(19) United States
(12) Patent Application Publication
(10) Pub. No.: US 2026/0333041 A1
(43) Pub. Date: Oct. 22, 2026

(54) AUTHENTICATIONS USING PASSWORD IDENTIFIERS

(71) Applicant: HEWLETT PACKARD ENTERPRISE DEVELOPMENT LP, Spring, TX (US)

(72) Inventors: Yanmin Liu, Beijing (CN); Yonglin Zhou, Beijing (CN)

(21) Appl. No.: 19/184,007

(22) Filed: Apr. 21, 2025

(51) Int. Cl. H04W 12/069; H04L 9/08; H04L 9/40

(52) U.S. Cl. CPC H04W 12/069; H04L 9/0861; H04L 63/083

(57) ABSTRACT

In some examples, a system receives a first password identifier provided by an electronic device as part of an authentication process in a network. The system accesses mapping information that correlates password identifiers to respective passwords. The system obtains, based on accessing the mapping information using the first password identifier, a first password for the electronic device, the first password useable by an access device in generating a key for secure communications in the network with the electronic device.

### BACKGROUND

A wireless network includes one or more access devices to which electronic devices can establish wireless connections to allow the electronic devices to communicate with other endpoint devices over the wireless network. Electronic devices may be associated with different roles that may govern what resources or services the electronic devices may be able to access using the wireless network.

### BRIEF DESCRIPTION OF THE DRAWINGS

Some implementations of the present disclosure are described with respect to the following figures.

FIG. 1 is a block diagram of an arrangement including a client device, an access point (AP), and an authentication server, according to some examples.

FIG. 2 is a flow diagram of a process involving the client device, the AP, and the authentication server, according to some examples.

FIG. 3 is a block diagram of a storage medium storing machine-readable instructions according to some examples.

FIG. 4 is a block diagram of an access device according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

For secure communication over a wireless network, an electronic device can perform an authentication process with a wireless access device of the wireless network to authenticate the electronic device before allowing the electronic device to connect to the access device. In some examples, a wireless network includes a wireless local area network (WLAN). The wireless access device in the WLAN is referred to as an access point (AP). A shared secret can be used to perform an authentication process between an electronic device and an AP. The shared secret can be a pre-shared key (PSK), which is also referred to as a password (or passphrase), according to the WI-FI Protected Access 2 (WPA2) wireless security protocol. WPA2 supports the Multi Pre-Shared Key (MPSK) feature, where multiple PSKs can be used in a WLAN. The multiple PSKs form an MPSK pool.

With a WPA2 authentication process, an AP or an authentication server connected to the AP can iterate through the PSKs of the MPSK pool to determine which PSK is used by an electronic device that is attempting to connect to the AP. Iterating through the PSKs of the MPSK pool is a brute-force technique that involves a search through potentially all the PSKs to find the relevant PSK for the electronic device. Although the foregoing brute-force technique of iterating through the PSKs of the MPSK pool for determining the PSK of the electronic device is possible with WPA2, such a technique is not available if a different authentication process is used, such as a WI-FI Protected Access 3 (WPA3) Simultaneous Authentication of Equals (SAE) authentication process. As a result, the AP or the authentication server would not be able to determine the PSK of an electronic device in the WPA3 SAE authentication process.

Additionally, the WPA3 SAE authentication process does not provide a mechanism to allow the AP or the authentication server to determine a role associated with an electronic device that is attempting to connect to the AP. The role associated with the electronic device can determine which of multiple different policies is applicable to the electronic device. Alternatively or additionally, the role associated with the electronic device can determine which of multiple virtual networks the electronic device is to access. If the role associated with the electronic device cannot be readily derived, then the AP would not be able to apply the correct policy and/or connect the electronic device to the appropriate virtual network.

In accordance with some implementations of the present disclosure, an electronic device initiates an authentication process for connecting to an access device of a network by sending an authentication message containing a first password identifier associated with a first password used by the electronic device. The first password can be a PSK that is part of an MPSK pool containing multiple PSKs for different electronic devices. A system uses the first password identifier to perform a lookup of mapping information that correlates password identifiers and an identifier of the network to respective passwords (e.g., the PSKs of the MPSK pool) and potentially other information, such as identifiers of virtual networks and roles. Based on the lookup of the mapping information using the first password identifier received from the electronic device, the system obtains the first password (and potentially other information) for the electronic device. The first password is useable by an access device in generating a key for secure communications in the network between the access device and the electronic device. Additionally, if the lookup of the mapping information produces an identifier of a given virtual network, the access device can allow the electronic device to communicate over the given virtual network. Further, if the lookup of the mapping information produces a given role associated with the electronic device, the access device can apply a role-based policy to manage access control for the electronic device.

Techniques or mechanisms according to some examples of the present disclosure can improve the relevant technology of secure communications in networks based on authenticating electronic devices and generating keys. A password identifier provided by an electronic device to initiate an authentication process allows an access device to obtain a password used by the electronic device, without having to perform a brute-force iteration through multiple passwords of a password pool to find the correct password. Also, the password identifier can be used to determine configuration information for the electronic device so that a corresponding configuration (e.g., connection to a virtual network, applying a role-based policy, etc.) can be established for the electronic device. Use of role-based policies allows for differentiated access of network resources or services for different electronic devices associated with different roles. Use of password identifiers to obtain passwords and configuration information reduces the complexity and cost associated with establishing secure connections of electronic devices to networks.

As used here, a "password" can refer to information used by a first device to allow authentication by a second device. The password can include a numeric value, an alphanumeric value, or any other type of information. A "password identifier" can refer to information (in the form of a numeric value, an alphanumeric string, a value derived from applying a function on an input value, etc.) that uniquely identifies a respective password from among a password pool. Note that a password identifier does not identify a user or another entity that may use or otherwise be associated with an electronic device. Rather, a password identifier is created for the purpose of distinguishing one password from another password in a password pool.

A role associated with an electronic device can indicate privileges, access rules, or other properties of the electronic device. For example, the role can include a user role of a user of the electronic device. Examples of user roles include a guest role for a guest that is visiting an enterprise operating a network, an employee role for an employee of the enterprise, a contractor role for a contractor of the enterprise, a role that is specific to a department of the enterprise that a user belongs to, a student role indicating that a user is a student at an educational organization, a teacher role indicating that a user is a teacher at the educational organization, or any other user role. Alternatively, a role associated with the electronic device can include a device role of the electronic device. Examples of device roles can include a role associated with a functionality of an electronic device (e.g., a printer, a user device, a storage system, etc.).

An "access device" can refer to a network device to which electronic devices can connect for access to a network. In some examples, the access device can include a wireless access device to which electronic devices can connect wirelessly for access to a wireless network. In further examples, the access device can include a wired access device to which electronic devices can establish wired connections for access to a wired network.

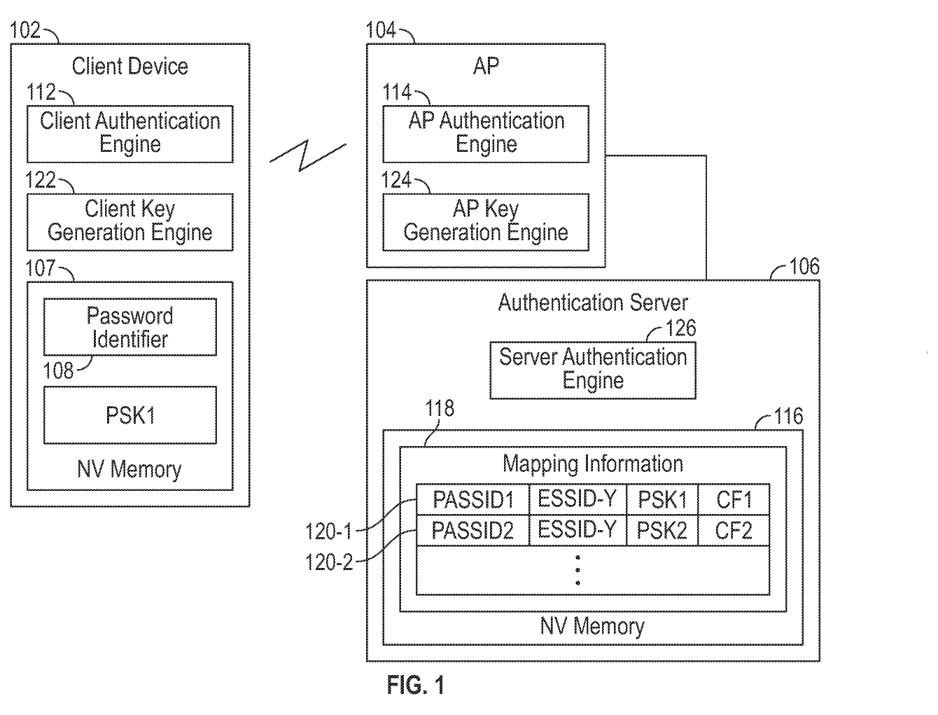

FIG. 1 is a block diagram of an example arrangement that includes a client device 102, an AP 104, and an authentication server 106. A "client device" can refer to an electronic device that seeks access to a network. In the example of FIG. 1, the network is a WLAN that includes the AP 104 (and possibly one or more other APs) to which the client device 102 can wirelessly connect. Although just one client device 102 is shown in FIG. 1, in other examples, multiple client devices can wirelessly connect to the AP 104.

Although reference is made to the AP 104 as an example of an access device in FIG. 1, in other examples, techniques or mechanisms according to some implementations of the present disclosure can be applied with other types of access devices, including wireless access devices for wireless networks or wired access devices for wired networks. In FIG. 1, the authentication server 106 is separate from the AP 104. In alternative examples, the authentication server 106 may be part of the AP 104.

An example type of WLAN is a WI-FI network that conforms to the Institute of Electrical and Electronics Engineers (IEEE) 802.11 standards. Other types of wireless networks can include a wireless personal area network (WPAN), a wireless metropolitan area network (WMAN), or another type of wireless network. An example of a wired network is an Ethernet network.

The client device 102 includes a client authentication engine 112 that can perform an authentication process with an AP authentication engine 114 of the AP 104. The client device 102 further includes a client key generation engine 122 that can interact with an AP key generation engine 124 of the AP 104 to generate one or more keys for use in secure communications between the client device 102 and the AP 104.

The client device 102 includes a nonvolatile memory 107 that stores a password identifier 108 and a password (e.g., PSK1 in FIG. 1). A nonvolatile memory is a memory that is able to maintain its stored content even if power were removed from the memory (or from an electronic device that the memory is part of). The nonvolatile memory 107 can be implemented using one or more nonvolatile memory devices. The password identifier 108 and the password PSK1 can be configured in the client device 102 by a provisioning system, which may be a configurator according to the Device Provisioning Protocol (DPP) (as defined by the WI-FI Easy Connect Specification) or a cloud management system, for example.

The password identifier 108 identifies PSK1. Different client devices can have different password identifiers to identify respective different PSKs. The PSKs that can be used in a WLAN including the AP 104 form an MPSK pool. For examples, the MPSK pool is associated with a single SSID or ESSID, which is an identifier of a group of devices including the AP 104 that can communicate with one another. An SSID identifies a basic service set (BSS) including a group of stations that can communicate with one another. The ESSID can include a group of associated BSSes. Stations can include APs and client devices.

In the ensuing discussion, reference is made to an ESSID that an MPSK pool is associated with. Generally, a pool of passwords can be associated with any identifier associated with a network.

In some examples, the client authentication engine 112 and the AP authentication engine 114 can perform a WPA3 SAE authentication process. The client key generation engine 122 and the AP key generation engine 124 can generate keys according to the WPA3 SAE protocol. The WPA3 SAE protocol is a password based authentication and key establishment protocol. In other examples, the client authentication engine 112, the AP authentication engine 114, the client key generation engine 122, and the AP key generation engine 124 can operate according to other authentication and key generation protocols, whether standardized, open-source, or proprietary. Other examples of authentication and key generation techniques include those according to the IEEE 802.1X protocol; the Extensible Authentication Protocol (EAP), such as EAS-TLS (Transport Layer Security) or EAS-TTLS (Tunneled Transport Layer Security); the Device Provisioning Protocol (DPP); or another protocol.

The authentication server 106 in some examples can include a Remote Authentication Dial-in User Service (RADIUS) server that performs authentication, authorization, and accounting (AAA) to manage network access for client devices. The RADIUS protocol is described in Request for Comments (RFC) 2865, dated June 2000. In other examples, the authentication server 106 can operate according to other authentication protocols, whether standardized, open-source, or proprietary. Another example of an authentication protocol is the Lightweight Directory Access Protocol (LDAP).

The authentication server 106 includes a server authentication engine 126 for performing authentication services (e.g., RADIUS services). The authentication server 106 also includes a nonvolatile memory 116 that stores mapping information 118 according to some examples of the present disclosure. The mapping information 118 can be in the form of a table, a graph, or any other type of data structure. The mapping information includes entries that correlate password identifiers and ESSID_Y (an identifier of an ESS) to respective PSKs and configuration information. For example, an entry 120-1 of the mapping information 118 correlates password identifier PASSID1 and ESSID_Y to the password PSK1 and configuration information CF1. Another entry 120-2 of the mapping information 118 correlates password identifier PASSID2 and ESSID_Y to password PSK2 and configuration information CF2.

In some examples, the configuration information in an entry can include the following configuration parameters: a role associated with a client device and an identifier of a virtual network on which the client device is to communicate. The virtual network can include a virtual local area network (VLAN), for example. Different client devices with different roles can be connected to different virtual networks.

Other entries (not shown) of the mapping information 118 can map other password identifiers and ESSID_Y to other passwords and configuration information. The passwords PSK1, PSK2, and so forth, form an MPSK pool to be used in an ESS identified by ESSID_Y.

Note that the mapping information 118 can also include entries that map password identifiers and other ESSIDs (different from ESSID_Y) to respective passwords and configuration information. Alternatively, the mapping information 118 can include entries for just ESSID_Y. The nonvolatile memory 116 can include other instances of mapping information for other ESSIDs.

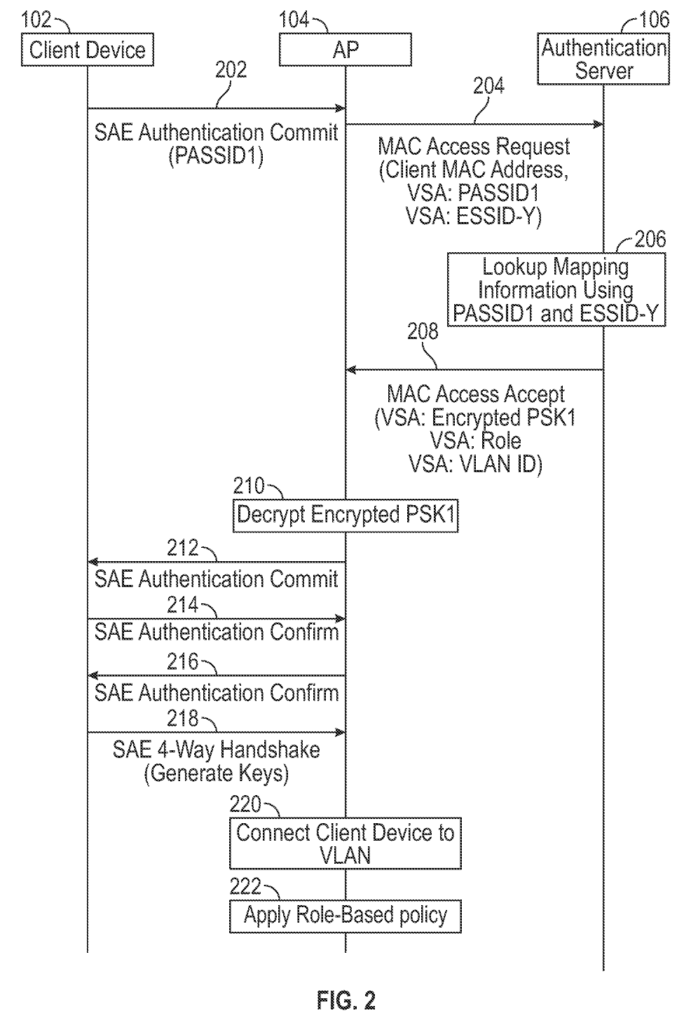

The following refers to FIGS. 1 and 2 .FIG. 2 is a flow diagram of a process involving the client device 102, the AP 104, and the authentication server 106. In the example of FIG. 2, it is assumed that the client device 102 and the AP 104 support WPA3 SAE authentication and key generation, and the authentication server 106 is a RADIUS server. In other examples, the client device 102, the AP 104, and the authentication server 106 can operate according to other protocols.

The client authentication engine 112 of the client device 102 sends (at 202) an SAE Authentication Commit message to the AP 104 to initiate the SAE authentication process between the client device 102 and the AP 104. In accordance with some examples of the present disclosure, the Commit message contains a password identifier (e.g., PASSID1) used by the client device 102. The Commit message can further include other information elements according to the SAE protocol. The password identifier included in the Commit message allows the AP 104 to obtain the password PSK1 used by the client device 102 from the authentication server 106.

The AP 104 responds to the Commit message by sending (at 204) a RADIUS Medium Access Control (MAC) Access Request message to the authentication server 106. The MAC Access Request message contains the MAC address of the client device 102 as well as other information elements according to some examples of the present disclosure. The other example information elements can be carried in vendor-specific attributes (VSAs) of the MAC Access Request message. A "VSA" of a message refers to an information element in the message that can be used to carry information customized for a specific use case.

In the example of FIG. 2, the MAC Access Request message can include VSAs containing PASSID1 and ESSID-Y. The password identifier PASSID1 was extracted by the AP 104 from the Commit message received from the client device 102. ESSID-Y identifies the ESS to which the AP 104 belongs.

The authentication server 106 responds to the MAC Access Request message from the AP 104 by performing (at 206) a lookup of the mapping information 118 using PASSID1 and ESSID-Y. The lookup includes searching the mapping information 118 for an entry (120-1) containing PASSID1 and ESSID-Y. The entry 120-1 identified by the lookup contains the password PSK1 and configuration information CF1.

The server authentication engine 126 of the authentication server 106 also performs an authentication of the client device 102 in response to the MAC Access Request message. If the authentication of the client device 102 is successful, the server authentication engine 126 of the authentication server 106 sends (at 208) a RADIUS MAC Access Accept message to the AP 104. The MAC Access Accept message indicates that the authentication at the authentication server 106 is successful. In some examples of the present disclosure, the MAC Access Accept message includes VSAs containing an encrypted version of the password PSK1 and configuration parameters, including role information specifying a role associated with the client device 102 and a VLAN identifier (ID) of a VLAN to which the client device 102 is to be connected.

In response to receiving the MAC Access Accept message, the AP 104 extracts the encrypted PSK1 and decrypts (at 210) the encrypted PSK1 to derive PSK1. After the AP 104 has derived PSK1 from the MAC Access Accept message, the AP authentication engine 114 of the AP 104 can continue with the SAE authentication process, including sending (at 212) an SAE Authentication Commit message to the client device 102. The client authentication engine 112 responds (at 214) with an SAE Authentication Confirm message, and the AP authentication engine 114 responds (at 216) with an SAE Authentication Confirm message. At this point, the SAE authentication process has successfully completed, and the AP 104 has authenticated the client device 102.

Next, the client device 102 sends (at 218) an association request to the AP 104 to associate with the AP 104. The association of the client device 102 with the AP 104 allows the client device 102 to establish a connection with the AP 104 so that the client device 102 can communicate over a WLAN. The AP 104 sends (at 220) an association response to the client device 102 to establish the wireless connection between the client device 102 and the AP 104.

Next, the client device 102 and AP 104 can perform (at 222) the SAE 4-way handshake to derive, using PSK1, additional keys for use in a secure connection between the client device 102 and the AP 104. The additional keys that are derived using PSK1 can include a Pairwise Master Key (PMK), from which a Pairwise Transient Key (PTK) can be derived. In examples where SAE key generation is used, a Diffie-Hellman exchange can be used to derive the PMK and the PTK. The PTK is used to encrypt unicast data sent between the client device 102 and the AP 104.

The AP 104 further connects (at 224) the client device 102 to the VLAN identified by the VLAN ID in the MAC Access Accept message. The AP 104 also applies (at 226) a role-based policy according to the role specified by the role information contained in the MAC Access Accept message. Different policies may be applied for different roles. For example, depending on the role associated with the client device 102, the AP 104 may allow or restrict access to certain resources or services of a network. As another example, the AP 104 may allow or restrict access to a destination outside or inside the WLAN. For example, if the role is a guest role, the client device 102 may not be allowed access to internal sites of a network. As another example, if the role is a student role, the client device 102 may not be allowed access to a destination outside a network.

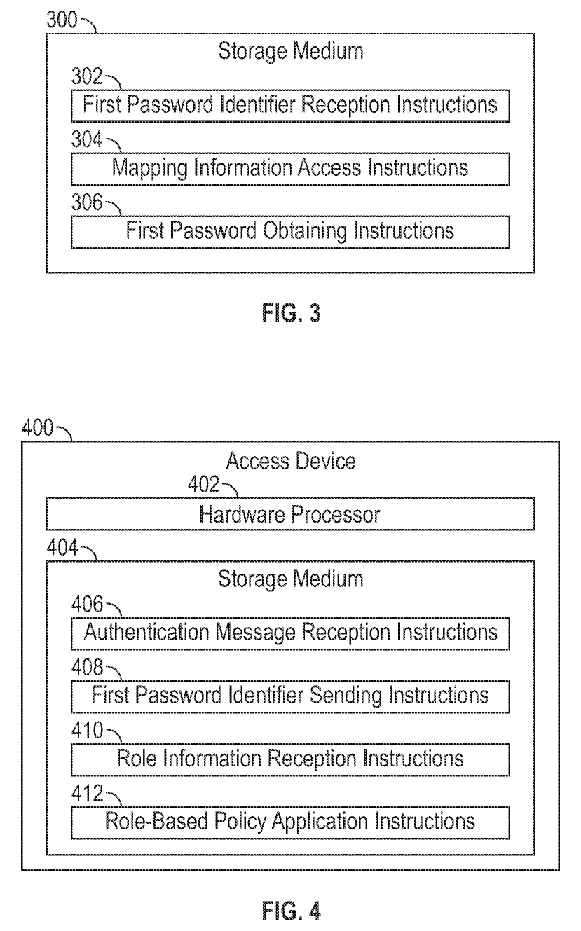

FIG. 3 is a block diagram of a non-transitory machine-readable or computer-readable storage medium 300 storing machine-readable instructions that upon execution cause a system to perform various tasks. In some examples, the system can include the AP 104 and/or the authentication server 106 of FIG. 1.

The machine-readable instructions include first password identifier reception instructions 302 to receive a first password identifier provided by an electronic device as part of an authentication process in a network. The electronic device may be the client device 102 of FIG. 1. The network may be a wireless or wired network.

The machine-readable instructions include mapping information access instructions 304 to access mapping information that correlates password identifiers to respective passwords. An example of the mapping information is the mapping information 118 of FIG. 1.

The machine-readable instructions include first password obtaining instructions 306 to obtain, based on accessing the mapping information using the first password identifier, a first password for the electronic device. The first password is useable by an access device (e.g., the AP 104 of FIG. 1) in generating a key for secure communications in the network with the electronic device.

In some examples, the system includes an authentication server (e.g., 106 in FIG. 1) storing the mapping information. The obtaining of the first password is performed by the authentication server. In some examples, the authentication server can send an encrypted version of the first password to the access device.

In some examples, the passwords include PSKs of an MPSK pool that are used for a given SSID identifying a set of stations in the network. The SSID may identify a BSS or may be an ESSID that identifies an ESS.

In some examples, the mapping information further correlates the password identifiers to respective roles. The system can obtain, based on accessing the mapping information using the first password identifier, a first role associated with the electronic device, where the first role is useable by an access device in policy-based access control of the network for the electronic device. The policy-based access control applies a role-based policy that depends upon the first role.

In some examples, the mapping information further correlates the password identifiers to respective virtual networks. The system can obtain, based on accessing the mapping information using the first password identifier, an identifier of a first virtual network over which the electronic device is to communicate.

In some examples, the system includes the access device, and the access device can generate the key for the secure communications in the network between the access device and the electronic device. For example, the key is generated according to a WPA3 SAE key generation process.

In some examples, the mapping information correlates the password identifiers and an identifier for the network to the respective passwords. The obtaining of the first password for the electronic device is based on a lookup of the mapping information using the first password identifier and the identifier for the network. The first password identifier is included in an authentication message from the electronic device. The identifier for the network may be an SSID or ESSID.

FIG. 4 is a block diagram of an access device 400 for a network. The access device 400 may be a wireless access device for a wireless network or a wired access device for a wired network.

The access device 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The access device 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include authentication message reception instructions 406 to receive an authentication message from an electronic device. The authentication message includes a first password identifier. The authentication message is to initiate an authentication process, such as a WPA3 SAE authentication process or another type of authentication process.

The machine-readable instructions in the storage medium 404 include first password identifier sending instructions 408 to send the first password identifier to an authentication server. An example of the authentication server is the authentication server 106 of FIG. 1. The first password identifier sent to the authentication server can be included in an authentication message, such as a RADIUS authentication message.

The machine-readable instructions in the storage medium 404 include role information reception instructions 410 to receive, at the access device from the authentication server, role information of a first role correlated to the first password identifier in mapping information accessible to the authentication server, where the mapping information correlates password identifiers to respective roles.

The machine-readable instructions in the storage medium 404 include role-based policy application instructions 412 to apply, based on the first role, a role-based policy for the electronic device in communications over the network. Different role-based policies are used for different roles.

In some examples, the access device can receive, from the authentication server, a first password correlated to the first password identifier in the mapping information. The access device can generate, using the first password, a key for secure communications between the access device and the electronic device.

In some examples, the first password is an encrypted version of the first password received in an authentication message from the authentication server.

In some examples, the first password is included in a VSA of an authentication message from the authentication server.

In some examples, the access device can receive, from the authentication server, an identifier of a virtual network correlated to the first password identifier in the mapping information. The access device can connect the electronic device to the virtual network based on the identifier of the virtual network.

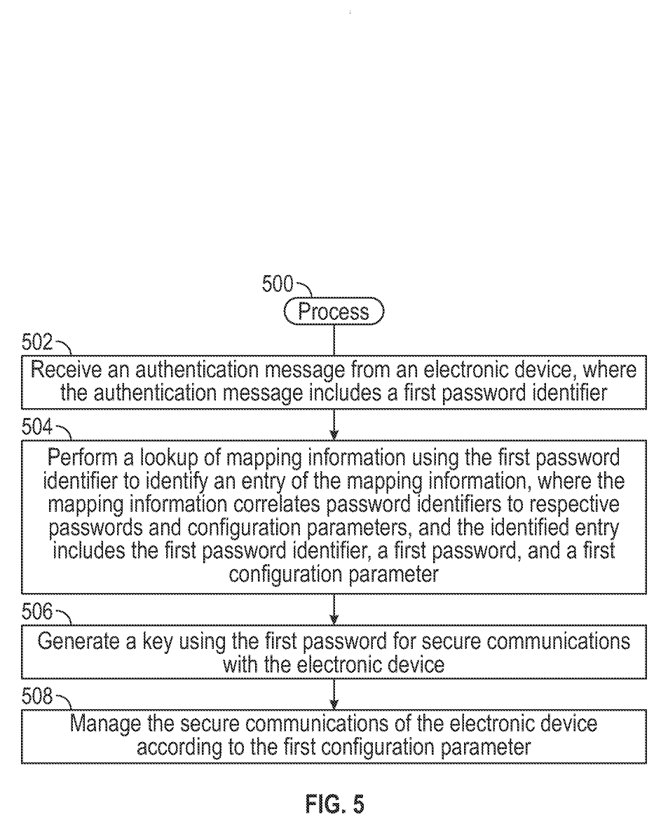

FIG. 5 is a flow diagram of a process 500 according to some examples of the present disclosure. The process 500 may be performed by a system that includes an access device (e.g., the AP 104 of FIG. 1) and/or an authentication server (e.g., 106 in FIG. 1).

The process 500 includes receiving (at 502) an authentication message from an electronic device, where the authentication message includes a first password identifier. The first password identifier identifies a password, such as a PSK.

The process 500 includes performing (at 504) a lookup of mapping information using the first password identifier to identify an entry of the mapping information, where the mapping information correlates password identifiers to respective passwords and configuration parameters, and the identified entry includes the first password identifier, a first password, and a first configuration parameter. In some examples, the first configuration parameter includes one or more of role information specifying a role associated with the electronic device or an identifier of a virtual network over which the electronic device is to communicate.

The process 500 includes generating (at 506) a key using the first password for secure communications with the electronic device. The key can be used to encrypt data communicated between the electronic device and an access device.

The process 500 includes managing (at 508) the secure communications of the electronic device according to the first configuration parameter. For example, the managing can include applying a role-based policy and/or connecting the electronic device to a virtual network.

As used here, an "engine" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an "engine" can refer to a combination of one or more hardware processing circuits and machine-readable instructions (software and/or firmware) executable on the one or more hardware processing circuits.

A nonvolatile memory device can include one or more of the following: a flash memory device, an erasable and programmable read-only memory (EPROM) device, an electrically erasable and programmable read-only memory (EEPROM) device, or another type of nonvolatile memory device.

FIGS. 2 and 5 are flow diagrams of processes including tasks performed in depicted orders. In other examples, the tasks of any of the processes may be performed in a different order, some of the tasks may be omitted, and other tasks may be added.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive a first password identifier provided by an electronic device as part of an authentication process in a network;
access mapping information that correlates password identifiers to respective passwords; and
obtain, based on accessing the mapping information using the first password identifier, a first password for the electronic device, the first password useable by an access device in generating a key for secure communications in the network with the electronic device.

2. The non-transitory machine-readable storage medium of claim 1, wherein the system comprises an authentication server storing the mapping information, and wherein the obtaining of the first password is performed by the authentication server.

3. The non-transitory machine-readable storage medium of claim 2, wherein the instructions upon execution cause the authentication server to:
send an encrypted version of the first password to the access device.

4. The non-transitory machine-readable storage medium of claim 1, wherein the passwords comprise pre-shared keys (PSKs) of a Multi Pre-Shared Key (MPSK) pool that are used for a given service set identifier (SSID) identifying a set of stations in the network.

5. The non-transitory machine-readable storage medium of claim 1, wherein the mapping information further correlates the password identifiers to respective roles, and wherein the instructions upon execution cause the system to:
obtain, based on accessing the mapping information using the first password identifier, a first role associated with the electronic device, the first role useable by the access device in policy-based access control of the network for the electronic device.

6. The non-transitory machine-readable storage medium of claim 1, wherein the mapping information further correlates the password identifiers to respective virtual networks, and wherein the instructions upon execution cause the system to:
obtain, based on accessing the mapping information using the first password identifier, an identifier of a first virtual network over which the electronic device is to communicate.

7. The non-transitory machine-readable storage medium of claim 1, wherein the system comprises the access device, and wherein the instructions upon execution cause the access device to:
generate the key for the secure communications in the network between the access device and the electronic device.

8. The non-transitory machine-readable storage medium of claim 7, wherein the key is generated according to a WI-FI Protected Access 3 (WPA3) Simultaneous Authentication of Equals (SAE) key generation process.

9. The non-transitory machine-readable storage medium of claim 1, wherein the mapping information correlates the password identifiers and an identifier for the network to the respective passwords, and wherein the obtaining of the first password for the electronic device is based on a lookup of the mapping information using the first password identifier and the identifier for the network, the first password identifier included in an authentication message from the electronic device.

10. The non-transitory machine-readable storage medium of claim 1, wherein the network is a wireless network, and the access device is a wireless access device.

11. An access device for a network, comprising:
a hardware processor; and
a non-transitory storage medium storing instructions executable on the hardware processor to:
receive an authentication message from an electronic device, the authentication message comprising a first password identifier;
send the first password identifier to an authentication server;
receive, at the access device from the authentication server, role information of a first role correlated to the first password identifier in mapping information accessible to the authentication server, the mapping information correlating password identifiers to respective roles; and
apply, based on the first role, a role-based policy for the electronic device in communications over the network.

12. The access device of claim 11, wherein the instructions are executable on the hardware processor to further:
receive, at the access device from the authentication server, a first password correlated to the first password identifier in the mapping information; and
generate, using the first password, a key for secure communications between the access device and the electronic device.

13. The access device of claim 12, wherein the first password is an encrypted version of the first password received in an authentication message from the authentication server.

14. The access device of claim 12, wherein the first password is included in a vendor-specific attribute of an authentication message from the authentication server.

15. The access device of claim 11, wherein the instructions are executable on the hardware processor to further:
receive, at the access device from the authentication server, an identifier of a virtual network correlated to the first password identifier in the mapping information; and
connect the electronic device to the virtual network based on the identifier of the virtual network.

16. The access device of claim 11, wherein the authentication message comprises a WI-FI Protected Access 3 (WPA3) Simultaneous Authentication of Equals (SAE) authentication message.

17. The access device of claim 11, wherein the instructions are executable on the hardware processor to:
send the first password identifier and an identifier for the network in a message to the authentication server,
wherein the mapping information correlates the password identifiers and the identifier of the network to the respective roles.

18. The access device of claim 17, wherein the mapping information correlates the password identifiers and the identifier for the network to the respective roles and to respective passwords.

19. A method comprising:
receiving, at a system comprising a hardware processor, an authentication message from an electronic device, the authentication message comprising a first password identifier;
performing, by the system, a lookup of mapping information using the first password identifier to identify an entry of the mapping information, the mapping information correlating password identifiers to respective passwords and configuration parameters, the identified entry comprising the first password identifier, a first password, and a first configuration parameter;
generating, by the system, a key using the first password for secure communications with the electronic device; and
managing, by the system, the secure communications of the electronic device according to the first configuration parameter.

20. The method of claim 19, wherein the first configuration parameter comprises one or more of role information specifying a role associated with the electronic device or an identifier of a virtual network over which the electronic device is to communicate.
